(19) United States
(12) Patent Application Publication
(10) Pub. No.: US 2010/0015589 A1
(43) Pub. Date: Jan. 21, 2010

(54) DENTAL TRAINING SYSTEM AND METHOD OF USE

(76) Inventor: Shlomo Lehavi, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 12/504,969

(22) Filed: Jul. 17, 2009

Related U.S. Application Data
(60) Provisional application No. 61/081,682, filed on Jul. 17, 2008.
(60) Provisional application No. 61/106,909, filed on Oct. 20, 2008.

(51) Int. Cl. G09B 23/28

(52) U.S. Cl. 434/263; 433/215

(57) ABSTRACT

A dental training system and method of use. The dental training system includes a haptic device configured to retain a dental tool and a computer having a processor and in communication with a display device and the haptic device. A software application is configured to display a mouth model on said display device, transform movements of said dental tool via said haptic device into corresponding visual movements of a brush icon on said display relative to said mouth model, evaluate the movements of the dental tool via said haptic device, and provide feedback to a user regarding the evaluation of the movements of the dental tool via the haptic device. The feedback being provided during and/or after a dental training session. The evaluation may utilize a comparison of a brush/floss session with stored brush/floss routines or acceptable data ranges. The haptic device may also be configured to respond to instructions from the computer to teach a user proper dental techniques.

### CROSS-REFERENCE TO RELATED APPLICATIONS

This application claims the benefit of U.S. Provisional Application No. 61/081,682 filed Jul. 17, 2008 and U.S. Provisional Application No. 61/106,909 filed Oct. 20, 2008.

### FIELD OF THE INVENTION

The embodiments of the present invention relate to a system and method for assisting persons with learning oral hygiene techniques.

### BACKGROUND

Oral care techniques, such as brushing teeth and dental flossing, are critical to the care and life of one's teeth. Despite the importance, many people fail to perform these techniques properly. Performing the techniques improperly results in poor oral health leading to teeth decay, disease and related problems which, in the best case, may cause one to lose their teeth at a tremendous emotional and financial expense, and in extreme cases, might cause death.

Poor oral health care, including poor teeth brushing and dental flossing is very common among children and also affects adults. One simple reason for such poor oral healthcare techniques is the fact that children are not effectively taught proper teeth brushing and dental flossing techniques. In most instances, parents are responsible for teaching their children the proper oral healthcare techniques when in many cases the parents do not know the proper techniques. Schools, assuming they teach dental techniques at all, similarly lack the proper knowledge and tools to adequately teach brushing teeth and dental flossing. Simply learning to I and floss teeth properly can save teeth and millions of dollars in healthcare costs annually. Rampant tooth decay is the single most common chronic childhood disease, 5 times more common than asthma. Indeed, cases of tooth decay continues the rise in the United States despite a ready solution in the form of proper education. Advantageously, once children learn the proper technique they will have it for life and can pass it along to their own children.

Therefore, there is a need for a better and more effective system and method of teaching one to properly brush and floss teeth. Advantageously, the system and method should be automated, engaging, easy to use and provide effective, immediate and post exercise feedback.

### SUMMARY

Accordingly, a first embodiment of the present invention is a system which utilizes a haptic device in combination with control software which forms a visual simulator for teaching the concepts of brushing and flossing teeth. The control software evaluates the physical movements and actions of a dental tool attached to the haptic device to provide the necessary sensational feedback and actual feedback to teach the user proper oral hygiene techniques. Three dimensional mouth models displayed on a monitor show dental tool icon movements corresponding to the haptic device as they relate to a displayed mouth model.

In one embodiment, the system is remotely monitored and used to assist stroke survivors and other handicapped individuals with re-learning the art of brushing and/or flossing. In this embodiment, the system may also guide the patient through the proper movements to re-educate the patient. Such guidance is in the form of the attached dental tool being physically guided by the haptics device whereby the patient may hold and feel the dental tool being used properly.

The embodiments of the present invention provide a system and method for teaching and/or re-teaching users teeth brushing and flossing techniques in a virtual environment. Advantageously, the system and method provide immediate sensory feedback typical of actual brushing and flossing, and evaluation feedback, including real time feedback and stored brushing/flossing sessions, to educate the user by showing the user errors which need improvement. The system and method also benefit those who teach the art of teeth brushing and flossing. That is, many persons designated to teach children and others to brush and floss teeth are not properly trained to do so and tend to create and pass along bad habits.

Other variations, embodiments and features of the present invention will become evident from the following detailed description, drawings and claims.

### BRIEF DESCRIPTION OF THE DRAWINGS

FIG. 1 illustrates a block diagram detailing a brush system according to the embodiments of the present invention;

FIG. 2 illustrates a block diagram detailing a software architecture according to the embodiments of the present invention;

FIGS. 3a-3c illustrate several exemplary screen shots of a display associated with the system according to the embodiments of the present invention;

FIG. 4 illustrates a block diagram of a system configured for remote monitoring according to the embodiments of the present invention;

FIG. 5 shows a block diagram of a floss system according to the embodiments of the present invention; and

FIG. 6 illustrates a flow chart detailing a methodology according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention utilize a haptic device (e.g., Falcon) of the type manufactured by Novint located in Albuquerque, N. Mex. Those skilled in the art will recognize that numerous other haptic device models are suitable as well. Haptic technology is technology that interfaces to the user via the sense of touch by applying forces, vibrations and/or motions to the user. More particularly, a mechanical stimulation is used to assist in the creation of virtual objects, for control of such virtual objects, and to enhance the remote control of machines and devices.

The embodiments of the present invention utilize hardware and software. Those skilled in the art will understand many known aspects of hardware and software such that for the sake of brevity, the description herein focuses on unique hardware and software features.

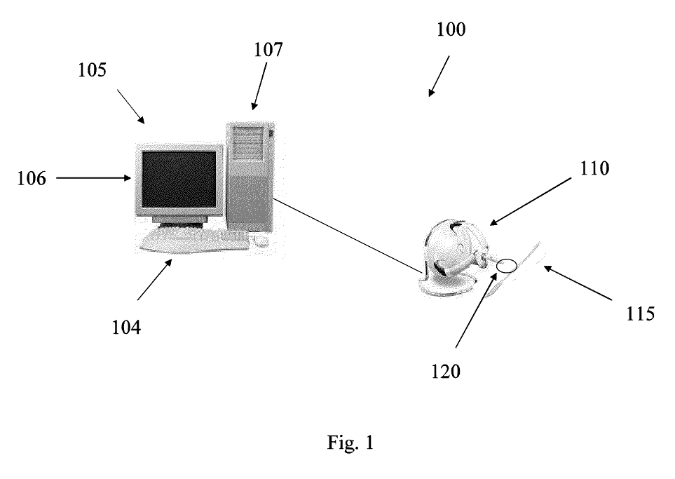

FIG. 1 shows a block diagram of a system 100 according to embodiments of the present invention. In a most basic sense, the system 100 includes a computer 105, haptic device 110 and toothbrush 115, with bristles 116, connected thereto via brush attachment 120. The brush attachment 125 may comprise any type of connector including snap-on, clip-on or other fastener technology which permits the toothbrush 115 to be removably attached to the haptic device 110. While a toothbrush 115 is shown for the user to handle, the haptic device item handled by the user to can be any item including a stylus, ball or any other user movement member which can be used to control the operations on a computer display 106. The computer 105 includes at least a display 106 and processor 107. The processor 107 may be dual core processor or any other type configured to control the system as described below. The computer 105 may also include an interface, such as a keyboard or touch screen technology, memory and related components typically associated with a computer. A storage device 108 communicates with the computer 105. Those skilled in the art will recognize that a computer may include server-based systems, hand-held devices and other processor-driven devices. For example, the embodiments of the present invention may be presented to users via an iPhone and other smart phone application.

The system may also include a server or other central location to which the computer, or at least a display and interface, is connected. In this embodiment, the server may include the processor 107 and storage device 108.

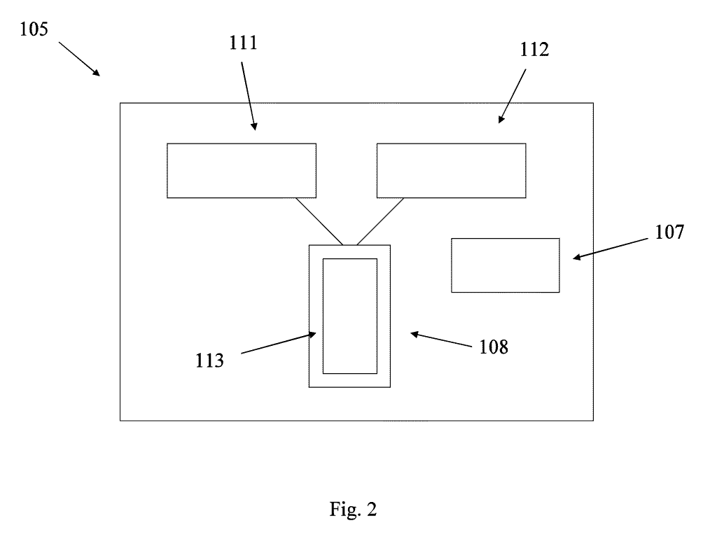

FIG. 2 illustrates a block diagram of a software architecture 106 comprising a brush module 111 and floss module 112. The brush module 111 and floss module 112 both communicate with a system database 113 maintained by said storage device 108. As described in more detail below, the system database 113 stores a plurality of mouth models and corresponding teeth, gum and tongue configurations. The mouth models are of varied sizes and shapes and seek to generically encompass a majority of common mouth types. The mouth models may include dental elements including fillings, crowns, braces, etc.

The mouth models are created using modeling software of a conventional nature. In one embodiment, the mouths are modeled after actual mouths of willing individuals. The modeling converts the parameters of physical three dimensional mouths into virtual software mouths which are used with the embodiments of the present invention. Initially the parameters of the subject mouth are captured using a scanning device adapted to fit into a subject's mouth. The captured parameters are converted into a virtual model. In another embodiment, plaster or dental stone is used to make a negative impression of the teeth. From the negative impression, a three dimensional mold can be created such that the parameters may be captured and converted into a virtual model. Modeling software of the type promoted by 3Shape of Denmark or 3D Science.com and many others may be used to convert the physical model to the virtual model or create virtual models without the need for a physical model. These methods may also be used to create a customized virtual model of a specific user.

In another embodiment, the virtual models are created from records. That is, virtual models may be created entirely from well-known and common mouth/teeth parameters which have been cataloged over time such that no live individuals need to be used to obtain measurements or molds. A generic mouth model may be created as well. That is, a generic mouth model may be used with the embodiments to teach the dental techniques expressed herein.

Once the virtual mouths are created, they are stored in the system database 113 where they may be accessed by the user via a user interface 104 (e.g., keyboard, touch screen, mouse or the haptic device 110) in communication with the computer 105. In one embodiment, the mouth models are adjustable by the user to open or close the teeth, rotate the mouth model and the like.

A brush module 111 is configured to facilitate a brush session whereby the user is able to learn the art of brushing teeth. The brush module 111 monitors the movements of the toothbrush 115 including the bristles 116 and causes the movements to be depicted on display 106 relative to a selected mouth model. The mouth model may be selected by the user from the database 113. The mouth model may be of a generic type or customized to match the user's mouth as discussed above.

In a first embodiment, the brush module 111 monitors the actions of the toothbrush 115 as controlled by the user. Movements of the toothbrush and bristles 115 are depicted on the display 106 relative to the selected mouth model such that the user observes the results of the actions of the toothbrush 115 as if the toothbrush 115 was in contact with the virtual teeth. In addition, the haptic device 110 transmits forces, vibrations and/or motions to the toothbrush 115 such that the user feels the effects of the toothbrush bristles 115 against the virtual teeth. This feedback provides the user with a realistic experience and generates muscle memory which as described below is useful in teaching the user the proper brushing technique.

The brush module 111 also evaluates the brushing technique administered by the user. The evaluation includes monitoring force, direction, time, angle and location of brush strokes. More particularly, the forces are monitored to determine whether the forces fall into a suitable range. Forces, whether too high or low, generates poor results. In addition, as described in detail below, the angle and location of the brush strokes is compared to a brush routine to make sure each falls into suitable ranges. Based on the evaluation, the user's brush technique can be graded or scored and, if necessary, ultimately improved. In one embodiment, the evaluation is based on a stored brush routine developed for each stored mouth model. That is, an ideal brush routine corresponding to each mouth model is stored in the database 113. In one embodiment, the brush routines are developed by a software application configured to recreate a virtual brush routine based on an actual brush routine designed for the specific individual's subject mouth model. In other words, the actual brush routine is used to develop the virtual brush routine. Alternatively, a software application is configured to develop a virtual brush routine based on the parameters of the virtual mouth model. In this instance, the software application is populated with desired force, direction, time, angle and location of brush strokes which the software application adapts to the subject mouth model. In either embodiment, the database 113 stores the brush routines in correspondence with the subject mouth model. The brush routine may also correspond to a generic mouth. Alternatively, the brush routine may be based on a conventional brush routine not associated with any specific mouth model. For example, one known brush routine comprises using short, gentle strokes, paying attention to the gumline, hard-to-reach back teeth and areas around fillings, crowns and other restorations concentrating on each section as follows: clean the outer surfaces of he upper teeth, then the lower teeth; clean the inner surfaces of the upper teeth, then the lower teeth; clean the chewing surfaces; and brush the tongue. In an alternative embodiment, routines are not used but the data acquired during the brush/floss session are evaluated based on desirable ranges associated with suitable brush/floss techniques. Accordingly, in one embodiment, suitable ranges for brush force, direction, time, angle and location of the toothbrush are established and stored. User's actions with the toothbrush or floss device causing data to fall outside of the stored ranges, trigger feedback during and/or after the session. The feedback may be simply visual in the sense that as plaque and food particles are removed, the user is visually cued to the results. Other feedback may be provided more directly in the form a text or audio. For example, text or audio may indicate ‘Brush Harder,’ ‘Brush Softer’ or “Change Brush Angle.’ Other evaluation and comparison techniques and routines may be stored as well.

The evaluation is accomplished using software forming the brush module 111 and the haptic device 110 controller (or processor) such that the two act to evaluate and create a realistic brush experience. In this configuration, the haptic device 110 provides user feedback in the form of forces, vibrations and/or motions which mimic those forces, vibrations and/or motions associated with brushing teeth while the controller for the haptic device 110 communicates with the brush module 111 to transform or convert user manipulation of the haptic device 110, in conjunction with the selected mouth model, into useable brush data and interactive measurements corresponding to brush force, direction, time, angle and location of the toothbrush bristles 116 on the simulated teeth, gum and tongue.

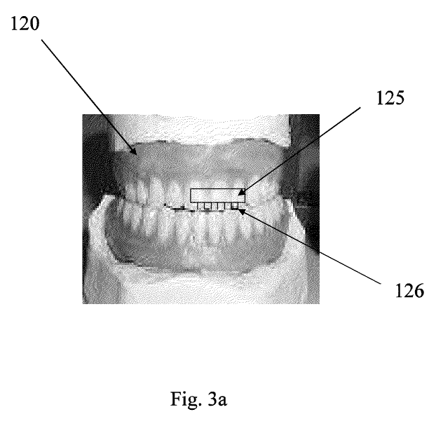

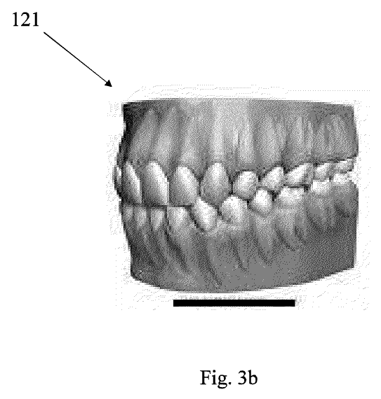

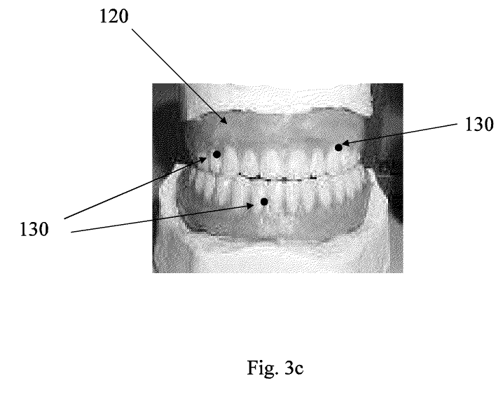

During a brush session, as shown in FIGS. 3a-3b, display 106 depicts the selected mouth/teeth 120 and in one embodiment, a toothbrush 125, including bristles 126, which identifies a virtual location of contact between the physical toothbrush 115 and the selected mouth model 120. In one embodiment, the brush icon 125 is dimensioned and designed to match the brush head of the toothbrush 115 or a complete toothbrush. The user is able to manipulate the toothbrush 115, namely the bristles 116, thereby causing the brush icon 125, and bristles 126, to move in a corresponding manner. Depending on the user, the mouth model 120 may be shown in different perspectives. Two perspectives include facing the user (FIG. 3a) or facing away. Other mouth models 121 include side views (FIG. 3b). A perspective mouth model facing away from the user replicates a user brushing his or her own teeth while a perspective mouth model facing the user replicates an assistant (e.g., nurse or other caretaker) brushing another's teeth.

In one embodiment, as shown in FIG. 3c, plaque and/or food particles 130 are depicted in the virtual teeth 120. The user is able to use the toothbrush 115 and bristles 116 to remove the simulated, depicted plaque 130 and/or food particles 135. After a brush session (or during) the perspective of the mouth model 120 may be changed or altered

In one embodiment, the brush module 111 includes a bristle configuration sub-module which tracks movements of each of the bristles 126 in relationship to the mouth model, namely teeth and gums. Based on the tracking, the brush force, direction, time, angle and location of the toothbrush bristles 126 on the simulated teeth is determined. From this brush data, the brush module 111 evaluates the effect of the bristles 126 on the teeth and gums and ultimately generates a full analysis of the user's brush technique.

In one embodiment, the system is used to facilitate a teeth brushing game. In one such embodiment, one or more different mouth models, with different plaque and/or food particle patterns, are randomly presented to a user who attempts to clean them adequately within pre-determined time periods. The user is scored based on brush quality, time required, levels obtained, etc. Alternatively, the user may be presented with a simulated mouth model matching the user's mouth and requested to brush the teeth for a pre-determined time period (e.g., 2 minutes) during and/or after which an evaluation is conducted. As referenced above, feedback may also be provided during a brush or floss session.

Alternatively, the system 100 is used as a training tool for users. As a training tool, the user selects a mouth model or is presented with a random mouth model. The user is then prompted to utilize the toothbrush 115 to brush the simulated teeth 120. After and/or during a brush session, the user is provided with feedback identifying positive and negative brush actions. Feedback during the brush session may be in the form of audio comments, text and the like such that the user can immediately make changes to the their brushing or flossing technique. Immediate feedback provides a tremendous teaching tool. Feedback after the brush session is also important to educate the user for future efforts. In one embodiment, the brush session may be recorded and re-played for the user with audio and/or text feedback throughout the replay giving the user time to reflect and learn.

In one embodiment, the brush module 111 provides control instructions to the haptic device 110. More specifically, the brush module 111 directs movements of the toothbrush 115 as facilitated by the haptic device 110. In this embodiment, the user is able to hold and/or observe the toothbrush 115 and toothbrush 125 while the toothbrush 115 is physically manipulated and guided by the brush module 111 such that the user is able to feel and observe the proper brush technique thereby being taught muscle memory associated with proper brushing technique. As set for the below relative to stroke patients, manual dexterity may also be improved via use of the guided toothbrush 115 or physical movements of the toothbrush 115.

Stroke survivors require countless hours of rehabilitation designed to re-teach the stroke survivor basic coordination, muscle usage and manual dexterity. The embodiments of the present invention, provide an ideal system for facilitating the rehabilitation via the brushing and flossing activities. Moreover, the remotely monitored system provides caregivers with a simple and effective method of monitoring the rehabilitation including whether the patient is undertaking the assigned rehabilitation activities and the quality of activities undertaken. In addition, the patient learns the proper brushing and flossing techniques. While brushing and flossing assist with manual dexterity, it will be understood by those skilled in the art that the use of a haptic device for other purposes, including game play (e.g., tennis, ping pong), exercising, etc., is also useful to assist stroke patients with improving manual dexterity. In other words, by playing the game, for example, via the haptic device the stroke patient is improving manual dexterity which can be monitored remotely. The remote monitoring also saves the patient from traveling to a rehabilitation center or having a caregiver travel to the patient.

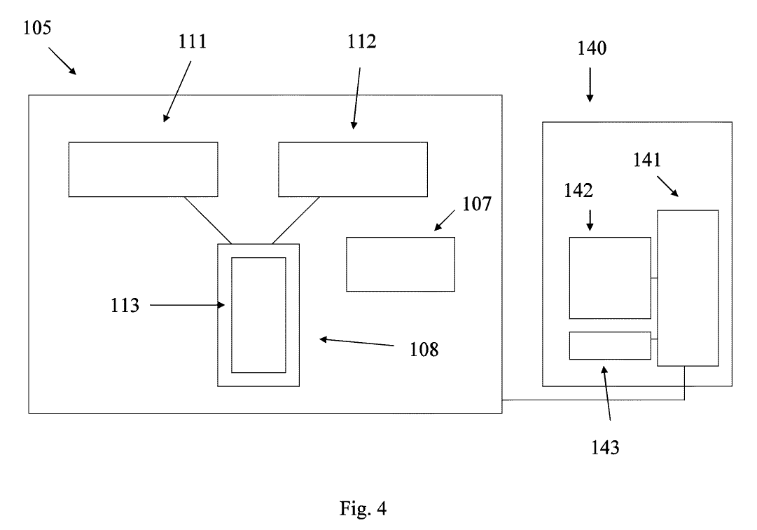

In one embodiment, the system 100 is configured for remote monitoring. This embodiment is ideal for stroke patients, the elderly or other handicapped persons. The computer 105, as shown in FIG. 4, is linked to a remote location 140. The link may be a wired or wireless connection which allows a doctor or other caregiver to monitor the patient's brushing technique and importantly assist the patient with improving or re-teaching the patient the proper brushing technique. In one embodiment, the connection is an Internet connection. The remote location 140 may have a computer 141, including a processor, monitor or display 142 and user interface 143, which allows the doctor or caregiver to directly and in real time monitor the patient's brushing technique. Alternatively, the caregiver may access a dedicated and password-protected website to observe the patient's brush technique. In either configuration, the caregiver may monitor real time brush data and formulate a training regiment responsive thereto.

With remote monitoring the caregiver may also monitor reports after the fact. In this manner, the caregiver is able to monitor a large number of people simultaneously. Importantly, the reports allow the caregiver to determine if the patients are brushing/flossing properly and also whether the patients are brushing/flossing in the first place. In other words, the caregiver is able to monitor whether the patients are brushing/flossing their teeth without having to see them face-to-face.

Advantageously, the caregiver may communicate with the patient or an individual in contact with the patient via the computer 105. Communications may be via email, instant message, webcam or in any other manner to allow the caregiver to advise and teach the patient the art of brushing/flossing.

This remote monitoring embodiment is important for several reasons. First, stroke patients, the elderly or other handicapped persons may need to re-learn the proper brushing technique to maintain the proper dental hygiene. Second, relearning the proper brushing technique can provide the patient with the confidence to move forward with improving or re-learning other physical skills.

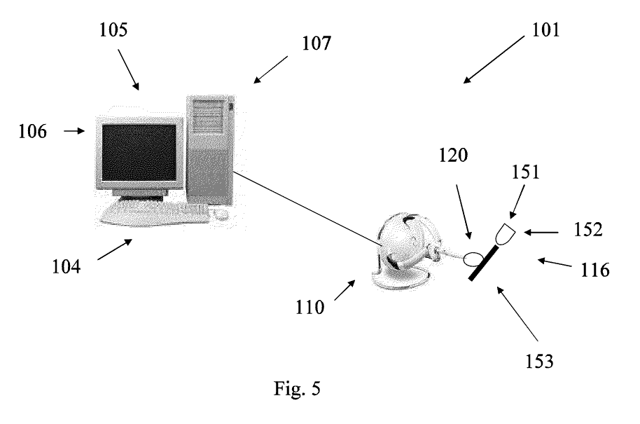

In another embodiment, as shown in FIG. 5, a system 101 operates in the same manner as system 100 but the haptic device 110 retains a floss device 116. The floss module 112 replicates the operations of the brush module 111 but relative to flossing techniques. In one embodiment, the floss device 116 comprises a segment of dental floss 151 stretched between a U-shaped head 152 having a handle 153 which is then retained by the haptic device 110. In this configuration, the user holds the handle 153 to undertake the flossing operation. A floss image 154 depicted on display 106 relative to a mouth model mimics the movements of the head of the floss device 116. An evaluation of the floss technique may be based on comparisons to stored, virtual floss routines.

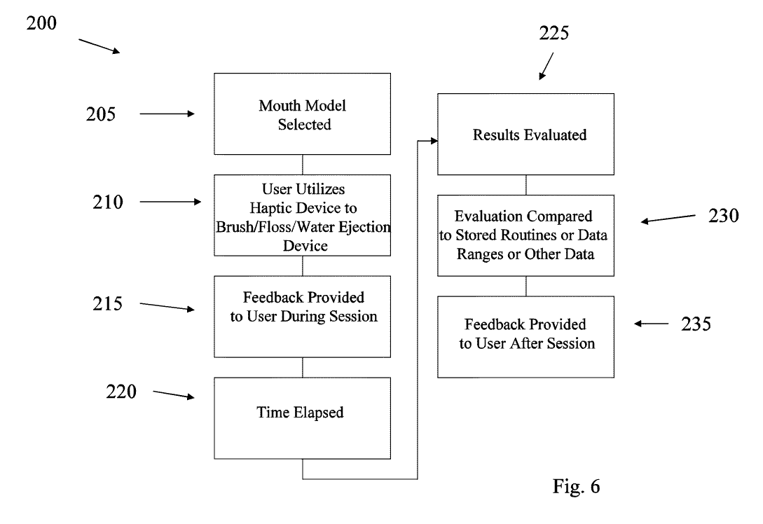

FIG. 6 shows a flow chart 200 detailing one method of utilizing the system according to the embodiments of the present invention. At 205, a user (e.g., caregiver, patient, student) selects a mouth model, which may include a model of the user's mouth, or a mouth model is randomly selected. At 210, the user operates the haptic device 110 and brushes or flosses the teeth of the mouth model. At 215, during the brush/floss session, feedback is provided to the user. The feedback comprises information based on the user's brush technique and may be in audio and/or visual form. At 220, after a pre-determined time period (e.g., 2 minutes) or after a session is completed (i.e., teeth cleaned), the brush or floss session is terminated. At 225, the results of the brush or floss are evaluated. At 230, the evaluation is compared to a stored, virtual brush or floss routine. At 235, based on the comparison, the user is provided with feedback regarding the brush or floss session and tips on improving the brush or floss technique.

It will be recognized by those skilled in the art that the embodiments of the present invention may be facilitated by any type of computer network, including countless hardware configurations, haptic device, toothbrush, floss device and modeling software for converting physical objects to virtual objects. In other embodiments, the system 100 is configured to provide training for use of an electric toothbrush and/or water ejection device (e.g., Water Pike®). In such embodiments, the system 100 includes an electric toothbrush module and water ejection device module, respectively, such that the system 100 depicts a visual electric toothbrush icon and water ejection device, respectively, which correspond to movements of an electric toothbrush and water ejection device (or representations thereof), respectively, connected to the haptics device. With the water ejection device, the water ejection module generates a realistic water stream against the mouth model. The water ejection session is evaluated against a stored water ejection routine with feedback being provided during and/or after the water ejection session. Consequently, the user is taught the proper water ejection device technique. The primary difference between the electric toothbrush and manual toothbrush is the action of the bristles. With the electric toothbrush the bristles are driven by the toothbrush. In many instances the bristles are in the form of one or two circular groupings which are then driven in a circular pattern. The user simply positions the bristles to clean the teeth. Thus, the electric toothbrush module replicates the actions of the circular moving bristles as the user moves the bristles across the simulated teeth, gums and/or tongue.

Although the invention has been described in detail with reference to several embodiments, additional variations and modifications exist within the scope and spirit of the invention as described and defined in the following claims.

I claim:

1. A dental training system comprising:
a haptic device having a user movement device;
a computer having a processor, said computer in communication with a display device and said haptic device; and
an application configured to:
display a mouth model on said display device;
convert movements of said user movement device via said haptic device into corresponding visual movements of an icon on said display relative to said mouth model;
convert movements of said user movement device via said haptic device into one or more interactive measurements between the icon and said mouth model;
evaluate the interactive measurements between the icon and said mouth model; and
provide feedback to a user regarding the evaluation of the measurements between the icon and mouth model, said feedback provided during and/or after a dental training session.

2. The dental training system of claim 1 wherein said user movement device is configured as a dental tool selected from the group comprising: a manual toothbrush, electric toothbrush, water ejection device or floss device.

3. The dental training system of claim 1 further comprising a storage device containing a plurality of mouth models.

4. The dental training system of claim 1 further comprising a storage device containing at least one of the following: a) virtual manual toothbrush, electric toothbrush, water ejection device and/or floss routines and b) acceptable data ranges.

5. The dental training system of claim 1 further comprising means for creating a custom mouth model.

6. The dental training system of claim 1 further comprising remote monitoring means.

7. The dental training system of claim 1 wherein said computer is server-based and/or hand-held.

8. The dental training system of claim 2 wherein said interactive measurements include brush force, direction, time, angle and location of manual or electric toothbrush bristles.

9. The dental training system of claim 2 wherein said application is further configured to model the actions of bristles associated with a dental tool comprising a manual or electric toothbrush.

10. A dental training system comprising:
a haptic device configured to retain a dental tool, said haptic device in communication with a computer, said computer in communication with a display device; and
a computer programmed to:
display a mouth model on said display device;
convert movements of said dental tool via said haptic device into corresponding visual movements of a icon on said display relative to said mouth model;
convert movements of said dental tool via said haptic device into interactive measurements between the icon and said mouth model;
evaluate the interactive measurements between the icon and said mouth model; and
provide feedback to a user regarding the evaluation of the interactive measurements between the icon and mouth model, said feedback provided during and/or after a dental training session.

11. The dental training system of claim 10 wherein said dental tool is a manual toothbrush, electric toothbrush, water ejection unit or floss device.

12. The dental training system of claim 10 further comprising a storage device containing at least one of the following: a) virtual manual toothbrush, electric toothbrush, water ejection device and/or floss routines and b) acceptable data ranges.

13. The dental training system of claim 10 further comprising a storage device containing a plurality of mouth models.

14. The dental training system of claim 10 further comprising means for creating a custom mouth model.

15. The dental training system of claim 10 further comprising remote monitoring means.

16. The dental training system of claim 10 wherein said interactive measurements include brush force, direction, time, angle and location of toothbrush bristles

17. The dental training system of claim 10 wherein the computer is further programmed to model the actions of bristles associated with a dental tool comprising a toothbrush

18. A dental training system comprising:
a haptic device configured to retain a dental tool;
a computer having a processor, said computer in communication with a display device and said haptic device; and
an application configured to:
control movements of the dental tool via the haptic device to teach a proper dental technique to a user; and
display movements of a dental tool icon on said display device wherein movements of said dental tool icon correspond to movements of the dental tool.

19. The dental training system of claim 18 wherein said application is further configured to:
display a mouth model on said display device;
convert movements of said dental tool via said haptic device into corresponding visual movements of a icon on said display relative to said mouth model;
convert movements of said dental tool via said haptic device into interactive measurements between the icon and said mouth model;
evaluate the interactive measurements between the icon and said mouth model; and
provide feedback to a user regarding the evaluation of the interactive measurements between the icons and mouth model, said feedback provided during and/or after a dental training session.

20. The dental training system of claim 19 further comprising a storage device containing at least one of the following: a) virtual manual toothbrush, electric toothbrush, water ejection device and/or floss routines and b) acceptable data ranges.

21. A method of teaching a dental technique comprising:
providing a haptic device with a user movement member;
linking a computer having a processor with a display device and said haptic device; and
programming said computer to:
display a mouth model on said display device;
convert movements of said user movement device via said haptic device into corresponding visual movements of an icon on said display relative to said mouth model;
convert movements of said user movement device via said haptic device into one or more interactive measurements between the icon and said mouth model;
evaluate the interactive measurements between the icon and said mouth model; and
provide feedback to a user regarding the evaluation of the interactive measurements between the icon and mouth model, said feedback provided during and/or after a dental training session.

22. The method of teaching a dental technique of claim 21 further comprising configuring said user movement device as a dental tool selected from the group comprising: a manual toothbrush, electric toothbrush, water ejection device or floss device.

23. The method of teaching a dental technique of claim 21 further comprising providing a storage device containing a plurality of mouth models.

24. The method of teaching a dental technique of claim 21 further comprising providing means for creating a custom mouth model.

25. The method of teaching a dental technique of claim 21 further comprising configuring the computer for remote monitoring.

26. The method of teaching a dental technique of claim 21 further comprising comparing brush or floss sessions to at least one of the following: a) virtual manual toothbrush, electric toothbrush, water ejection device and/or floss routines and b) suitable data ranges.

27. The method of teaching a dental technique of claim 22 further comprising modeling the actions of bristles associated with a dental tool comprising a manual or electric toothbrush.

28. A method of teaching a dental technique comprising:
configuring a haptic device to retain a dental tool;
linking a computer having a processor with a display device and said haptic device; and
configuring an application useable by said computer to:
display a mouth model on said display device;
convert movements of said dental tool via said haptic device into corresponding visual movements of a icon on said display relative to said mouth model;
convert movements of said dental tool via said haptic device into interactive measurements between the icon and said mouth model;
evaluate the interactive measurements between the icon and said mouth model; and
provide feedback to a user regarding the evaluation of the interactive measurements between the icon and mouth model, said feedback provided during and/or after a dental training session.

29. The method of teaching a dental technique of claim 28 further comprising providing a storage device containing a plurality of mouth models.

30. The method of teaching a dental technique of claim 28 further comprising providing means for creating a custom mouth model.

31. The method of teaching a dental technique of claim 28 further comprising configuring the computer for remote monitoring.

32. The method of teaching a dental technique of claim 28 further comprising comparing manual toothbrush, electric toothbrush, water ejection device or floss sessions to at least one of the following: a) virtual manual toothbrush, electric toothbrush, water ejection device and/or floss routines and b) suitable data ranges.

33. The method of teaching a dental technique of claim 28 further comprising modeling the actions of bristles associated with a dental tool comprising a toothbrush.

34. A method of treating handicapped persons comprising:
providing a haptic device with a user movement member;
linking a computer having a processor with a display device and said haptic device; and
programming said computer to:
display an application requiring a user to move said user movement member;
convert movements of said user movement device via said haptic device into corresponding visual movements of an icon on said display relative to said application;
convert movements of said user movement device via said haptic device into movements of the icon relative to said application; and
remotely linking a second display device to said computer allowing remote monitoring of said movements of said user movement member by said user.
